(19) United States
(12) Patent Application Publication
(10) Pub. No.: US 2008/0032239 A1
(43) Pub. Date: Feb. 7, 2008

(54) Pattern formation method

(76) Inventors: Masayuki Endo, Osaka (JP); Masaru Sasago, Osaka (JP)

Correspondence Address: MCDERMOTT WILL & EMERY LLP, 600 13TH STREET, NW, WASHINGTON, DC, 20005-3096, US

(21) Appl. No.: 11/808,952

(22) Filed: Jun. 14, 2007

(30) Foreign Application Priority Data
Aug. 2, 2006 (JP) 2006-210790

(51) Int. Cl. G03C 5/00

(52) U.S. Cl. 430/324

(57) ABSTRACT

In the pattern formation method, a resist film is formed on a substrate, and a barrier film is formed on the resist film. Thereafter, with a liquid provided on the barrier film, pattern exposure is performed by selectively irradiating the resist film with exposing light through the barrier film. After the pattern exposure, the barrier film is exposed to a water displacing agent, and then, the resist film having been subjected to the pattern exposure is developed, so as to remove the barrier film and to form a resist pattern made of the resist film.

### CROSS-REFERENCE TO RELATED APPLICATIONS

This application claims priority under 35 U.S.C. §119 on Patent Application No. 2006-210790 filed in Japan on Aug. 2, 2006, the entire contents of which are hereby incorporated by reference.

### BACKGROUND OF THE INVENTION

The present invention relates to a pattern formation method employing immersion lithography for use in fabrication process or the like for semiconductor devices.

In accordance with the increased degree of integration of semiconductor integrated circuits and downsizing of semiconductor devices, there are increasing demands for further rapid development of lithography technique. Currently, pattern formation is carried out through photolithography using exposing light of a mercury lamp, KrF excimer laser, ArF excimer laser or the like, and use of F₂ laser lasing at a shorter wavelength of 157 nm is being examined. However, since there remain a large number of problems in exposure systems and resist materials, photolithography using exposing light of a shorter wavelength has not been put to practical use.

In these circumstances, immersion lithography has been recently proposed for realizing further refinement of patterns by using conventional exposing light (for example, see M. Switkes and M. Rothschild, “Immersion lithography at 157 nm”, J. Vac. Sci. Technol., Vol. B19, p. 2353 (2001)).

In the immersion lithography, a region in an exposure system sandwiched between a projection lens and a resist film formed on a wafer is filled with a liquid having a refractive index n (whereas n>1) and therefore, the NA (numerical aperture) of the exposure system has a value n-NA. As a result, the resolution of the resist film can be improved.

Also, in order to further increase the refractive index in the immersion lithography, use of an acidic solution as the immersion liquid has been proposed (see, for example, B. W. Smith, A. Bourov, Y. Fan, L. Zavyalova, N. Lafferty, F. Cropanese, “Approaching the numerical aperture of water—Immersion Lithography at 193 nm”, Proc. SPIE, Vol. 5377, p. 273 (2004)).

Now, a conventional pattern formation method employing the immersion lithography will be described with reference to FIGS. 5A through 5D, 6A and 6B.

First, a positive chemically amplified resist material having the following composition is prepared:

| | | |
|---|---|---|
| Base polymer: poly((norbornene-5-methylene-t- | 2 | g |
| butylcarboxylate) (50 mol %) - (maleic anhydride) | | |
| (50 mol %)) | | |
| Acid generator: triphenylsulfonium trifluoromethane sulfonate | 0.05 | g |
| Quencher: triethanolamine | 0.002 | g |
| Solvent: propylene glycol monomethyl ether acetate | 20 | g |

Next, as shown in FIG. 5A, the aforementioned chemically amplified resist material is applied on a substrate 1 so as to form a resist film 2 with a thickness of 0.35 μm.

Then, as shown in FIG. 5B, a barrier film 3 having a thickness of 0.03 μm is formed on the resist film 2 by, for example, spin coating by using a barrier film material having the following composition:

| | |
|---|---|
| Base polymer: polyvinyl hexafluoroisopropyl alcohol | 1 g |
| Solvent: n-butyl alcohol | 20 g |

Next, as shown in FIG. 5C, the resultant barrier film 3 is baked with a hot plate at a temperature of 120° C. for 90 seconds.

Then, as shown in FIG. 5D, with an immersion liquid 4 of water provided on the barrier film 3, pattern exposure is carried out by irradiating the resist film 2 through the liquid 4 and the barrier film 3 with exposing light 5 of ArF excimer laser having NA of 0.68 having passed through a mask 6.

After the pattern exposure, as shown in FIG. 6A, the resist film 2 is baked with a hot plate at a temperature of 105° C. for 60 seconds, and thereafter, the resultant resist film 2 is developed with a 2.38 wt % tetramethylammonium hydroxide developer. In this manner, a resist pattern 2a made of an unexposed portion of the resist film 2 and having a line width of 0.09 μm is formed as shown in FIG. 6B.

However, as shown in FIG. 6B, the resist pattern 2a obtained by the conventional pattern formation method is in a defective shape.

The present inventors have variously examined the reason why the resist pattern 2a formed by the conventional immersion lithography is in a defective shape, resulting in finding the following:

In the immersion lithography, the barrier film 3 is formed on the resist film 2 for preventing the performance of the resist film 2 from degrading through contact with the immersion liquid 4. Although the liquid 4 provided on the barrier film 3 is collected after the exposure, there still remains a droplet on the barrier film 3. The droplet remaining on the barrier film 3 permeates through the barrier film 3 into the resist film 2, so that the acid generator included in the resist film 2 can be extracted by the permeating liquid 4. Therefore, the resist film 2 cannot be sufficiently chemically amplified after the development and the post exposure bake. As a result, what is called a bridge defect in which top portions of adjacent patterns are bridged to each other is caused.

When the resist pattern in such a defective shape is used for etching a target film, the resultant pattern of the target film is also in a defective shape, which disadvantageously lowers the productivity and the yield in the fabrication process for semiconductor devices.

### SUMMARY OF THE INVENTION

In consideration of the aforementioned conventional problems, an object of the invention is forming a fine pattern in a good shape by preventing an immersion liquid remaining on a barrier film from permeating into a resist film through the barrier film.

In order to achieve the object, in the pattern formation method employing the immersion lithography of this invention, a barrier film is exposed to a water displacing agent after exposure.

The present inventors have found through various examinations that permeation of an immersion liquid into a resist film through a barrier film can be prevented by removing a droplet remaining on the barrier film through displacement or decomposition with a water displacing agent. Specifically, the water displacing agent incorporates the droplet for displacement, and the thus displaced droplet is decomposed to eliminate. For accelerating the elimination of the droplet, what is called rotational shake for shaking the droplet off by rapidly rotating a substrate may be performed after the exposure to the water displacing agent. It is noted that the water displacing agent does not affect the pattern formation because it is vaporized in post exposure bake. Also, the quantity of heat (i.e., a baking temperature or a baking time) of the post exposure bake may be increased for more easily vaporizing a water content from the water displacing agent.

A barrier film formed on a resist film is designed not to be mixed with the resist film, and in general, when a barrier film is formed on a resist film, even a water displacing agent mixable with the resist film can displace and decompose a droplet without mixing with the barrier film.

The present invention was devised on the basis of the aforementioned finding, and is specifically practiced as follows:

The first pattern formation method of this invention includes the steps of forming a resist film on a substrate; forming a barrier film on the resist film; performing pattern exposure by selectively irradiating the resist film with exposing light through the barrier film with a liquid provided on the barrier film; exposing the barrier film to a water displacing agent after the pattern exposure; and removing the barrier film and forming a resist pattern made of the resist film by developing the resist film having been subjected to the pattern exposure after exposing the barrier film to the water displacing agent.

The second pattern formation method of this invention includes the steps of forming a resist film on a substrate; forming a barrier film on the resist film; performing pattern exposure by selectively irradiating the resist film with exposing light through the barrier film with a liquid provided on the barrier film; exposing the barrier film to a water displacing agent after the pattern exposure; removing the barrier film after exposing the barrier film to the water displacing agent; and forming a resist pattern made of the resist film by developing the resist film having been subjected to the pattern exposure after removing the barrier film.

In the first or second pattern formation method, the barrier film is exposed to the water displacing agent after the pattern exposure, and hence, a droplet remaining on the barrier film is removed through displacement or decomposition with the water displacing agent. Therefore, since permeation of the liquid into the resist film through the barrier film can be prevented after the pattern exposure, the expected performance of a resist material used for forming the resist film can be kept, so that a fine pattern can be formed in a good shape. Also, even in the case where the water displacing agent itself is reactive with the resist material, since the banier film is formed on the resist film in this invention, the reaction between the water displacing agent and the resist material can be prevented.

In the aforementioned manner, the barrier film of this invention may be removed during or before the development, and both have their advantages as follows: When the barrier film is removed during the development of the resist film as in the first pattern formation method, the dissolution characteristic of the resist film can be advantageously controlled to be improved. In other words, when the barrier film is removed simultaneously with the development, the dissolution characteristic of the resist film can be controlled to given extent. On the other hand, when the barrier film is removed before the development as in the second pattern formation method, the following development can be smoothly performed.

Now, the dissolution characteristic of a resist film will be described with reference to FIG. 7. In general, when the dissolution characteristic of a resist film is high, the dissolution rate is abruptly increased when exposure exceeds a given threshold value (a threshold region of FIG. 7) (as shown with a graph A of a broken line in FIG. 7). As the change of the dissolution rate against the exposure is more abrupt, a difference in the solubility between an exposed portion and an unexposed portion of the resist film is larger, and hence, the resist pattern can be more easily formed in a good shape. Accordingly, in the case where the barrier film is removed during the development, the dissolution rate is wholly lowered correspondingly to the removal of the barrier film, and hence, the change in a portion surrounded with a circle C in FIG. 7 can be reduced to be flatter. As a result, in the case where the actual resist film has the dissolution characteristic as shown with a graph B, the dissolution rate attained with smaller exposure can be adjusted to be comparatively constant at a low dissolution rate even when the small exposure varies to some extent. Accordingly, a difference in the solubility between an exposed portion and an unexposed portion of the resist film can be easily caused, resulting in easily forming a resist pattern in a good shape.

In the first or second pattern formation method, the water displacing agent can be paraffin or isoparaffin.

In the first or second pattern formation method, a spraying method or a puddle method can be employed in the step of exposing the barrier film to the water displacing agent.

The first or second pattern formation method preferably further includes, after the step of exposing the barrier film to a water displacing agent, a step of subjecting the resist film to a thermal treatment.

In the first or second pattern formation method, the barrier film may include, as a base polymer, polyvinyl alcohol, polyacrylic acid or polyvinyl hexafluoroisopropyl alcohol.

The first or second pattern formation method preferably further includes, after the step of forming a barrier film and before the step of performing pattern exposure, a step of subjecting the barrier film to a thermal treatment. Thus, the denseness of the barrier film is improved, and hence, the insolubility in the liquid provided thereon in the exposure is increased. However, when the denseness of the barrier film is increased too much, the barrier film is difficult to remove, and therefore, it is preferably baked at a temperature in an appropriate range of, for example, not less than 100° C. and not more than 150° C., which does not limit the invention because the temperature also depends upon the composition or the thickness of the barrier film.

In the first or second pattern formation method, the liquid may be water or an acidic solution.

In this case, the acidic solution can be a cesium sulfate (Cs₂SO₄) aqueous solution or a phosphoric acid (H₃PO₄) aqueous solution.

It is noted that a surface active agent or the like may be included in the immersion liquid.

In the first or second pattern formation method, the exposing light can be KrF excimer laser, Xe₂ laser, ArF excimer laser, F₂ laser, KrAr laser or Ar₂ laser.

### BRIEF DESCRIPTION OF THE DRAWINGS

FIGS. 1A, 1B, 1C and 1D are cross-sectional views for showing procedures in a pattern formation method according to Embodiment 1 of the invention;

FIGS. 2A, 2B and 2C are cross-sectional views for showing other procedures in the pattern formation method of Embodiment 1;

FIGS. 3A, 3B, 3C and 3D are cross-sectional views for showing procedures in a pattern formation method according to Embodiment 2 of the invention;

FIGS. 4A, 4B, 4C and 4D are cross-sectional views for showing other procedures in the pattern formation method of Embodiment 2;

FIGS. 5A, 5B, 5C and 5D are cross-sectional views for showing procedures in a conventional pattern formation method;

FIGS. 6A and 6B are cross-sectional views for showing other procedures in the conventional pattern formation method; and

FIG. 7 is a graph for explaining control of solubility of a resist in the pattern formation method of this invention.

### DETAILED DESCRIPTION OF THE INVENTION

### Embodiment 1

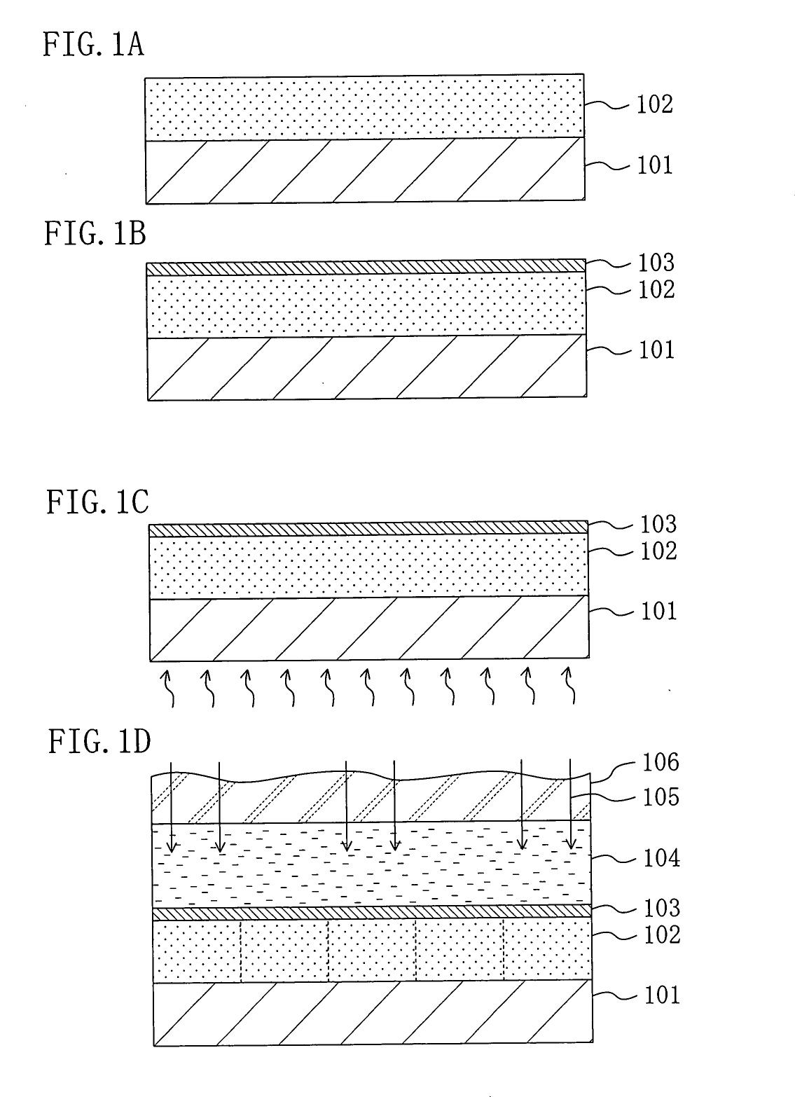

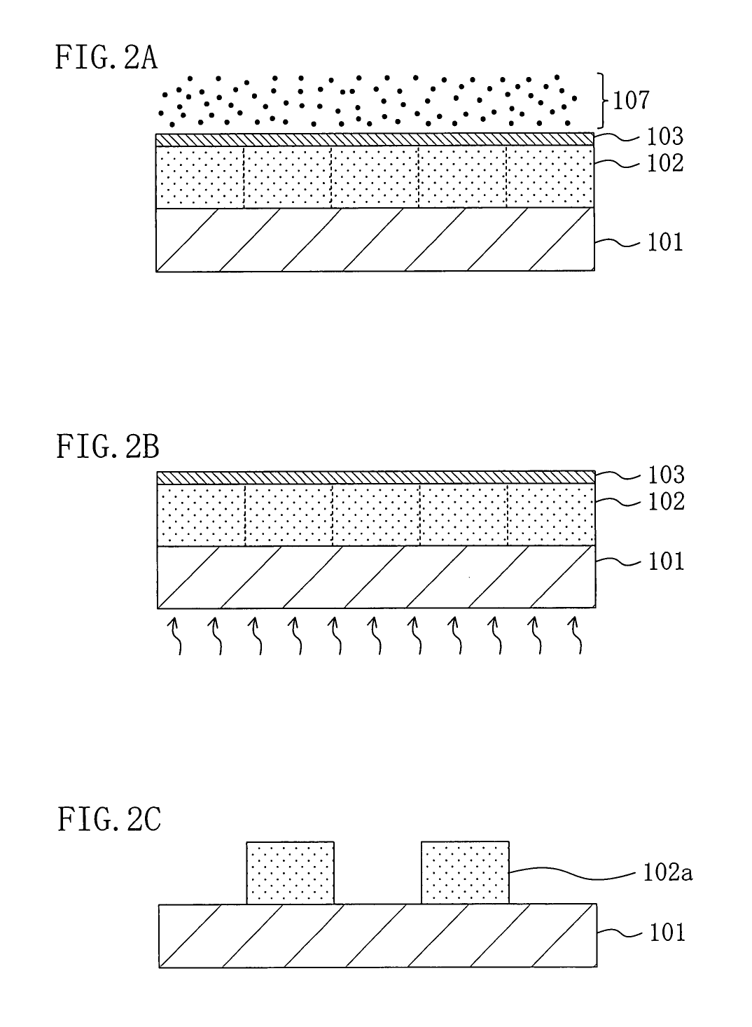

A pattern formation method according to Embodiment 1 of the invention will now be described with reference to FIGS. 1A through 1D and 2A through 2C.

First, a positive chemically amplified resist material having, for example, the following composition is prepared:

| | | |
|---|---|---|
| Base polymer: poly((norbornene-5-methylene-t- | 2 | g |
| butylcarboxylate) (50 mol %) - (maleic anhydride) | | |
| (50 mol %)) | | |
| Acid generator: triphenylsulfonium trifluoromethane sulfonate | 0.05 | g |
| Quencher: triethanolamine | 0.002 | g |
| Solvent: propylene glycol monomethyl ether acetate | 20 | g |

Next, as shown in FIG. 1A, the aforementioned chemically amplified resist material is applied on a substrate 101 so as to form a resist film 102 with a thickness of 0.35 μm.

Then, as shown in FIG. 1B, by using a barrier film material having the following composition, a barrier film 103 having a thickness of 0.03 μm is formed on the resist film 102 by, for example, spin coating:

| | |
|---|---|
| Base polymer: polyvinyl hexafluoroisopropyl alcohol | 1 g |
| Solvent: n-butyl alcohol | 20 g |

Next, as shown in FIG. 1C, the resultant barrier film 103 is baked with a hot plate at a temperature of 120° C. for 90 seconds, so as to improve the denseness of the barrier film 103.

Then, as shown in FIG. 1D, an immersion liquid 104 of water is provided between the barrier film 103 having been baked and a projection lens 106 by, for example, a puddle method. In this state, pattern exposure is carried out by irradiating the resist film 102 through the liquid 104 and the barrier film 103 with exposing light 105 of ArF excimer laser with NA of 0.68 having passed through a mask (not shown).

After the pattern exposure, as shown in FIG. 2A, the liquid 104 disposed on the barrier film 103 is removed, and subsequently, a water displacing agent 107 of liquid paraffin is sprayed onto the barrier film 103 for 10 seconds, thereby exposing the surface of the barrier film 103 to the water displacing agent 107.

Next, as shown in FIG. 2B, together with the barrier film 103 having been exposed to the water displacing agent 107, the resist film 102 having been subjected to the pattern exposure is baked with a hot plate at a temperature of 105° C. for 60 seconds (post exposure bake).

Thereafter, the barrier film 103 is removed and the resultant resist film 102 is developed with a 2.38 wt % tetramethylammonium hydroxide developer. Thus, a resist pattern 102a made of an unexposed portion of the resist film 102 and having a line width of 0.09 μm is formed in a good shape as shown in FIG. 2C.

In this manner, according to Embodiment 1, in the surface treatment with the water displacing agent 107 shown in FIG. 2A, the surface of the barrier film 103 formed on the resist film 102 is exposed to the paraffin, that is, the water displacing agent 107, and hence, a droplet remaining on the barrier film 103 is incorporated into the paraffin. As a result, the droplet remaining on the barrier film 103 is easily evaporated to be removed. Thus, the droplet remaining on the barrier film 103 can be prevented from permeating into the resist film 102 through the barrier film 103, and hence, the acid generator or the like included in the resist film 102 is never extracted. In other words, the expected performance of the resist film 102 can be kept, resulting in forming the resist pattern 102a in a good shape.

### Embodiment 2

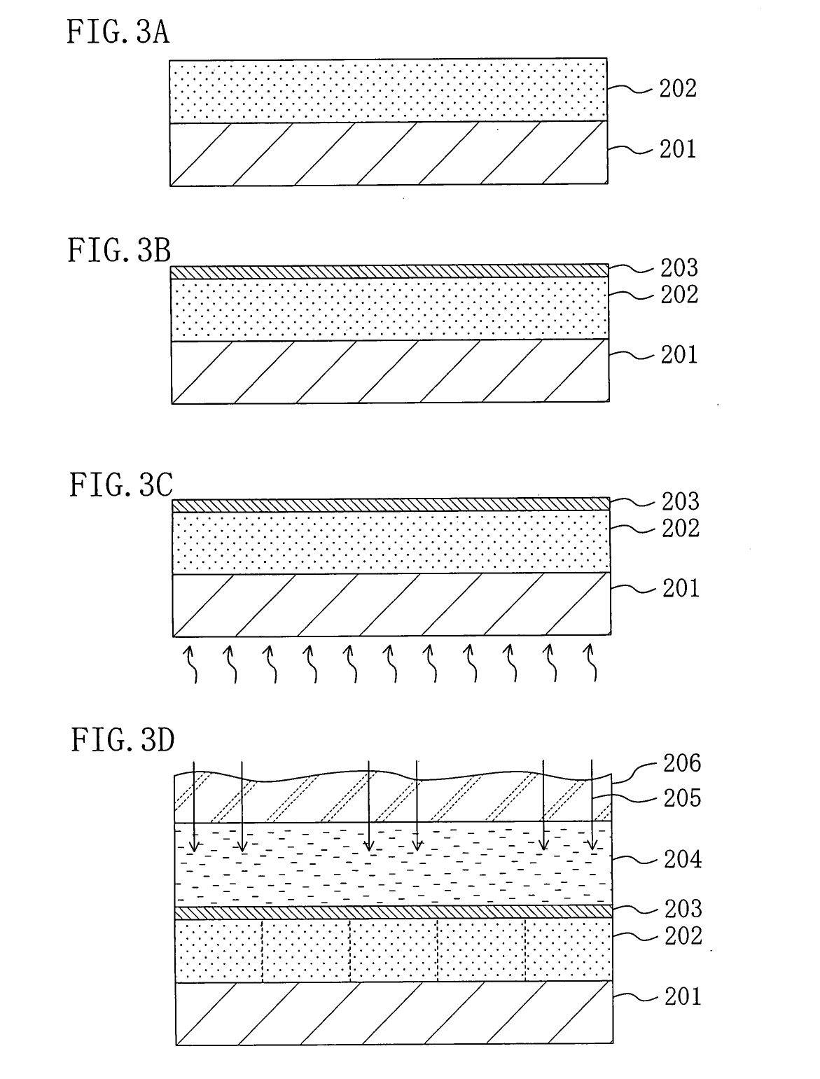

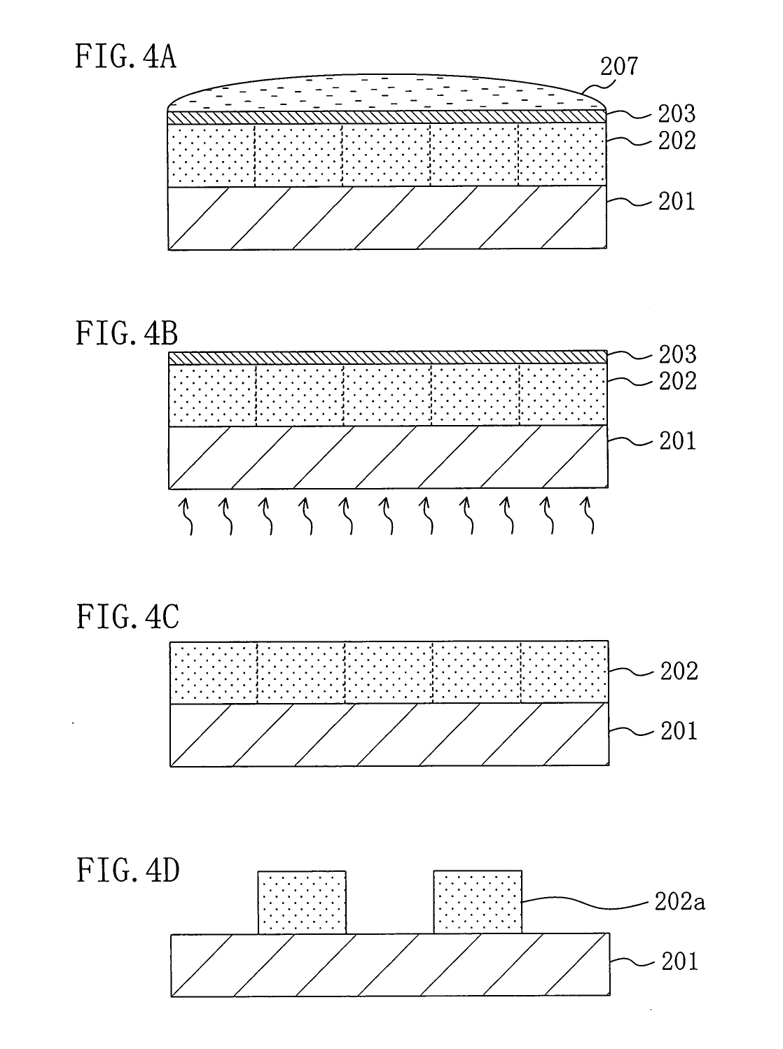

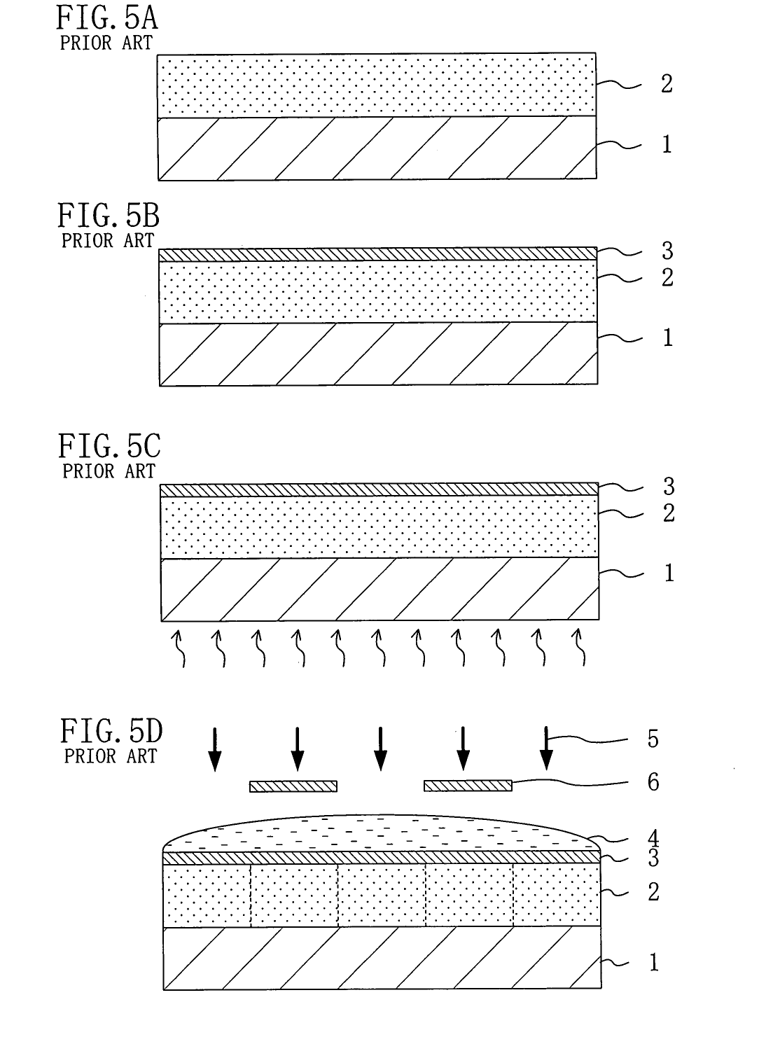

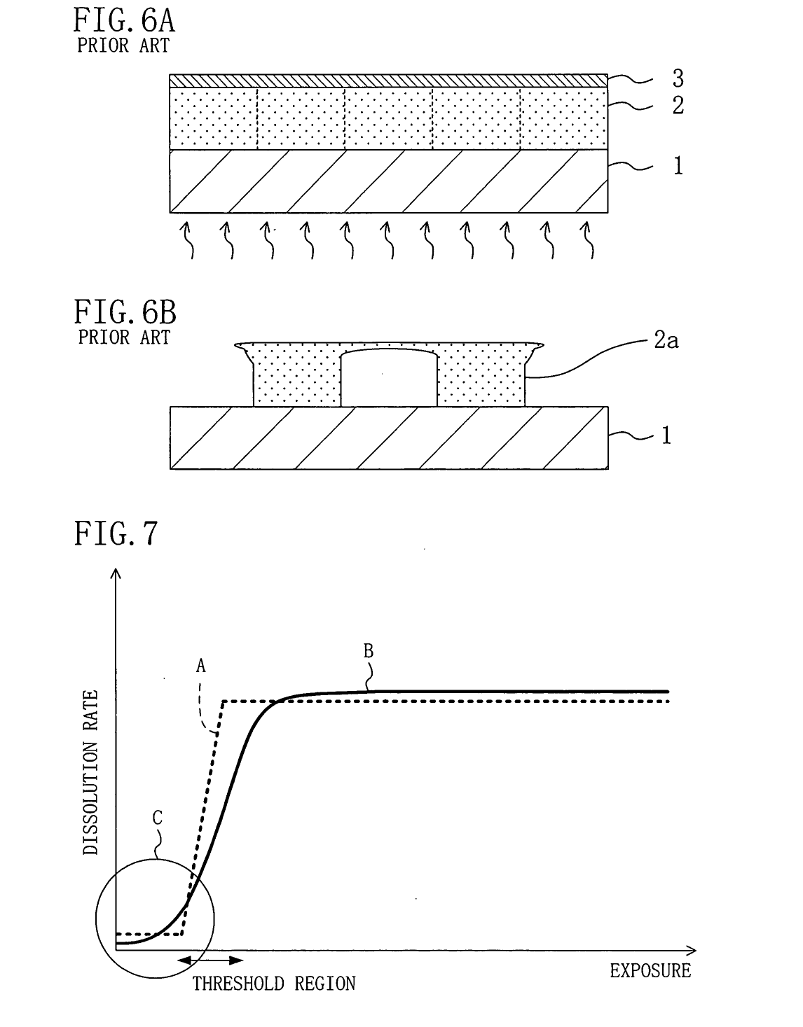

A pattern formation method according to Embodiment 2 of the invention will now be described with reference to FIGS. 3A through 3D and 4A through 4D.

First, a positive chemically amplified resist material having, for example, the following composition is prepared:

| | | |
|---|---|---|
| Base polymer: poly((norbornene-5-methylene-t- | 2 | g |
| butylcarboxylate) (50 mol %) - (maleic anhydride) | | |
| (50 mol %)) | | |
| Acid generator: triphenylsulfonium trifluoromethane sulfonate | 0.05 | g |
| Quencher: triethanolamine | 0.002 | g |
| Solvent: propylene glycol monomethyl ether acetate | 20 | g |

water displacing agent, the resist film 202 having been subjected to the pattern exposure is baked with a hot plate at a temperature of 105° C. for 60 seconds (post exposure bake).

Next, as shown in FIG. 4C, the barrier film 203 is removed with, for example, a 0.05 wt % tetramethylammonium hydroxide aqueous solution (a diluted alkaline developer). Thereafter, the resultant resist film 202 is developed with a 2.38 wt % tetramethylammonium hydroxide developer. Thus, a resist pattern 202a made of an unexposed portion of the resist film 202 and having a line width of 0.09 μm is formed in a good shape as shown in FIG. 4D.

In this manner, according to Embodiment 2, in the surface treatment with the water displacing agent 207 shown in FIG. 4A, the surface of the barrier film 203 formed on the resist film 202 is exposed to the isoparaffin, that is, the water displacing agent 207, and hence, a droplet remaining on the barrier film 203 is incorporated into the isoparaffin. As a result, the droplet remaining on the barrier film 203 is easily evaporated to be removed. Thus, the droplet remaining on the barrier film 203 can be prevented from permeating into the resist film 202 through the barrier film 203, and hence, the acid generator or the like included in the resist film 202 is never extracted. In other words, the expected performance of the resist film 202 can be kept, resulting in forming the resist pattern 202a in a good shape.

In each of Embodiments 1 and 2, the barrier film for preventing direct contact, with the resist film, of the immersion liquid provided on the resist film is provided, and the barrier film of each embodiment is never mixed with the paraffin or the like used as the water displacing agent. However, if the resist film is directly exposed to the water displacing agent without providing the barrier film of each embodiment on the resist film, the resist film and the water displacing agent are mixed with each other, and hence, the thus formed resist pattern is in a defective shape.

Next, as shown in FIG. 3A, the aforementioned chemically amplified resist material is applied on a substrate 201 so as to form a resist film 202 with a thickness of 0.35 μm.

Then, as shown in FIG. 3B, by using a barrier film material having the following composition, a barrier film 203 having a thickness of 0.07 μm is formed on the resist film 202 by, for example, the spin coating:

| | |
|---|---|
| Base polymer: polyacrylic acid | 1 g |
| Solvent: isobutyl alcohol | 20 g |

Next, as shown in FIG. 3C, the resultant barrier film 203 is baked with a hot plate at a temperature of 120° C. for 90 seconds, so as to improve the denseness of the barrier film 203.

Next, as shown in FIG. 3D, an immersion liquid 204 of an aqueous solution including 5 wt % of cesium sulfate (Cs₂SO₄) is provided between the baked barrier film 203 and a projection lens 206 by, for example, the puddle method. In this state, pattern exposure is carried out by irradiating the resist film 202 through the liquid 204 and the barrier film 203 with exposing light 205 of ArF excimer laser with NA of 0.68 having passed through a mask (not shown).

After the pattern exposure, as shown in FIG. 4A, the barrier film 203 is exposed to a water displacing agent 107 of liquid isoparaffin for 20 seconds by, for example, the puddle method.

Then, as shown in FIG. 4B, the water displacing agent 207 is removed by a shaking treatment, and thereafter, together with the barrier film 203 having exposed to the

Furthermore, the barrier film materials described in the respective embodiments are merely examples, and as a base polymer, that is, the principal component of the barrier film material, may be polyvinyl alcohol, polyacrylic acid or polyvinyl hexafluoroisopropyl alcohol.

Moreover, the thickness of the barrier film is 0.03 μm through 0.07 μm in each embodiment. However, the thickness is not limited to this range but the lower limit of the thickness of the barrier film is a thickness capable of preventing a component of the resist film from eluting into the immersion liquid or preventing the immersion liquid from permeating into the resist film, and the upper limit of the thickness is a thickness that does not prevent transmission of the exposing light and can be easily removed. Also, the barrier film is subjected to the thermal treatment after its formation in each embodiment, but such a thermal treatment of the barrier film is not always necessary but may be appropriately performed depending upon the composition, the thickness and the like of the barrier film.

Also in Embodiment 1, cesium sulfate may be included in the immersion liquid as in Embodiment 2 for increasing the refractive index of the liquid. The compound thus included in the liquid is not limited to cesium sulfate but may be phosphoric acid (H₃PO₄). Furthermore, a surface active agent may be added to the liquid.

Although the exposing light is ArF excimer laser in each embodiment, the exposing light is not limited to it but may be KrF excimer laser, Xe₂ laser, F₂ laser, KrAr laser or Ar₂ laser instead.

Furthermore, the puddle method is employed for providing the liquid onto the barrier film in each embodiment, which does not limit the invention, and for example, a dip method in which the whole substrate is dipped in the liquid may be employed instead.

Moreover, the composition of the chemically amplified resist described in each embodiment is merely an example and the chemically amplified resist may have another composition. Although a positive chemically amplified resist is used for forming the resist film in each embodiment, the present invention is applicable also to a negative chemically amplified resist. Furthermore, the invention is applicable not only to a chemically amplified resist but also to a general resist.

As described so far, according to the pattern formation method of this invention, a fine pattern can be formed in a good shape through the immersion lithography, and the invention is useful for, for example, a pattern formation method employing the immersion lithography.

What is claimed is:

1. A pattern formation method comprising the steps of:
forming a resist film on a substrate;
forming a barrier film on said resist film;
performing pattern exposure by selectively irradiating said resist film with exposing light through said barrier film with a liquid provided on said barrier film;
exposing said barrier film to a water displacing agent after the pattern exposure; and
removing said barrier film and forming a resist pattern made of said resist film by developing said resist film having been subjected to the pattern exposure after exposing said barrier film to said water displacing agent.

2. The pattern formation method of claim 1,
wherein said water displacing agent is paraffin or isoparaffin.

3. The pattern formation method of claim 1,
wherein a spraying method or a puddle method is employed in the step of exposing said barrier film to a water displacing agent.

4. The pattern formation method of claim 1, further comprising, after the step of exposing said barrier film to a water displacing agent, a step of subjecting said resist film to a thermal treatment.

5. The pattern formation method of claim 1,
wherein said barrier film includes a polymer made of polyvinyl alcohol, polyacrylic acid or polyvinyl hexafluoroisopropyl alcohol.

6. The pattern formation method of claim 1, further comprising, after the step of forming a barrier film and before the step of performing pattern exposure, a step of subjecting said barrier film to a thermal treatment.

7. The pattern formation method of claim 1,
wherein said liquid is water.

8. The pattern formation method of claim 1,
wherein said liquid is an acidic solution.

9. The pattern formation method of claim 8,
wherein said acidic solution is a cesium sulfate aqueous solution or a phosphoric acid aqueous solution.

10. The pattern formation method of claim 1,
wherein said exposing light is KrF excimer laser, Xe₂ laser, ArF excimer laser, F₂ laser, KrAr laser or Ar₂ laser.

11. A pattern formation method comprising the steps of:
forming a resist film on a substrate;
forming a barrier film on said resist film;
performing pattern exposure by selectively irradiating said resist film with exposing light through said barrier film with a liquid provided on said barrier film;
exposing said barrier film to a water displacing agent after the pattern exposure;
removing said barrier film after exposing said barrier film to said water displacing agent; and
forming a resist pattern made of said resist film by developing said resist film having been subjected to the pattern exposure after removing said barrier film.

12. The pattern formation method of claim 11,
wherein said water displacing agent is paraffin or isoparaffin.

13. The pattern formation method of claim 1,
wherein a spraying method or a puddle method is employed in the step of exposing said barrier film to said water displacing agent.

14. The pattern formation method of claim 11, further comprising, after the step of exposing said barrier film to a water displacing agent, a step of subjecting said resist film to a thermal treatment.

15. The pattern formation method of claim 1,
wherein said barrier film includes a polymer made of polyvinyl alcohol, polyacrylic acid or polyvinyl hexafluoroisopropyl alcohol.

16. The pattern formation method of claim 11, further comprising, after the step of forming a barrier film and before the step of performing pattern exposure, a step of subjecting said barrier film to a thermal treatment.

17. The pattern formation method of claim 11,
wherein said liquid is water.

18. The pattern formation method of claim 1,
wherein said liquid is an acidic solution.

19. The pattern formation method of claim 18,
wherein said acidic solution is a cesium sulfate aqueous solution or a phosphoric acid aqueous solution.

20. The pattern formation method of claim 1,
wherein said exposing light is KrF excimer laser, Xe₂ laser, ArF excimer laser, F₂ laser, KrAr laser or Ar₂ laser.
